(19) United States
(12) Patent Application Publication
(10) Pub. No.: US 2026/0121086 A1
(43) Pub. Date: Apr. 30, 2026

(54) SEPARATOR FOR ELECTROCHEMICAL DEVICE, ELECTROCHEMICAL DEVICE

(71) Applicant: SAMSUNG ELECTRO-MECHANICS CO., LTD., Suwon-si (KR)

(72) Inventors: Myoung Hoon KIM, Suwon-si (KR); Sun Il JEONG, Suwon-si (KR); Seok Ho YU, Suwon-si (KR)

(73) Assignee: SAMSUNG ELECTRO-MECHANICS CO., LTD., Suwon-si (KR)

(21) Appl. No.: 19/252,275

(22) Filed: Jun. 27, 2025

(30) Foreign Application Priority Data
Oct. 31, 2024 (KR) 10-2024-0151822

(51) Int. Cl. H01M 8/026; C25B 9/19; C25B 13/02; H01M 8/10

(52) U.S. Cl. CPC H01M 8/026; C25B 9/19; C25B 13/02; H01M 2008/1095

(57) ABSTRACT

A separator for an electrochemical device including: a fluid inlet; a fluid outlet; a plurality of first flow paths connected to the fluid inlet; and a plurality of second flow paths connected to the fluid outlet and the first flow path, wherein in a connection region in which the plurality of first flow paths and the plurality of second flow paths are connected to each other, two second flow paths, adjacent to each other, are connected to one first flow path among the plurality of first flow paths, and two first flow paths, adjacent to each other, are commonly connected to one second flow path among the plurality of second flow paths.

### CROSS-REFERENCE TO RELATED APPLICATION(S)

This application claims benefit of priority to Korean Patent Application No. 10-2024-0151822 filed on Oct. 31, 2024 in the Korean Intellectual Property Office, the disclosure of which is incorporated herein by reference in its entirety.

### TECHNICAL FIELD

The present disclosure relates to a separator for an electrochemical device, and an electrochemical device.

Electrochemical devices include fuel cells that generate electrical energy by electrochemically reacting fuel (hydrogen) and an oxidizer (pure oxygen, or oxygen in the atmosphere), and electrolysis cells that generate hydrogen and oxygen through electrolysis of water.

As an example of such electrochemical devices, a polymer electrolyte membrane fuel cell (PEMFC) and a polymer electrolyte membrane water electrolysis cell (PEMEC) are eco-friendly energy source devices using hydrogen and are attracting attention because of their high efficiency and miniaturization. Generally, a polymer electrolyte membrane fuel cell and a polymer electrolyte membrane water electrolysis cell include a membrane-electrode assembly (MEA) in which a polymer electrolyte membrane is disposed between catalyst electrodes. Additionally, a solid oxide fuel cell (SOFC) and a solid oxide electrolysis cell (SOEC) include a cell composed of an air electrode, a fuel electrode, and a solid electrolyte having oxygen ion conductivity, and here, the cell may be referred to as a solid oxide cell. A solid oxide cell produces electrical energy through an electrochemical reaction or produces hydrogen by electrolyzing water through a reverse reaction of a solid oxide fuel cell. In addition thereto, other types of fuel cells or electrolytic cells, such as phosphoric acid fuel cells (PAFC), alkaline fuel cells (AFC), and direct methanol fuel cells (DMFC), are also used as a type of electrochemical device.

In the case of electrochemical devices, it is common to use a stack structure in which a unit cell is disposed between a pair of separators, and here, the separators have a flow path formed through which fluids may flow. Fluids such as water, water vapor, hydrogen, and oxygen gas may flow through a flow path of the separator, and a direction, speed, and a flow rate of the fluid flow greatly affect the performance of the electrochemical device. Accordingly, research has been conducted in the relevant technical field recently to optimize the size and shape of the flow path.

### SUMMARY

One aspect of the present disclosure is to implement a separator for an electrochemical device designed to provide high performance when applied to an electrochemical device.

In order to resolve the above-described aspect, an example embodiment of the present disclosure provides a separator for an electrochemical device including: a fluid inlet; a fluid outlet; a plurality of first flow paths connected to the fluid inlet; and a plurality of second flow paths connected to the fluid outlet and the plurality of first flow paths, wherein in a connection region in which the plurality of first flow paths and the plurality of second flow paths are connected to each other, two second flow paths among the plurality of second flow paths and, adjacent to each other are connected to one first flow path among the plurality of first flow paths, and two first flow paths among the plurality of first flow paths and adjacent to each other are commonly connected to one second flow path among the plurality of second flow paths.

In an example embodiment, at least one first flow path among the plurality of first flow paths may be a linear flow path.

In an example embodiment, at least one second flow path among the plurality of second flow paths may be a linear flow path.

In an example embodiment, a number of second flow paths in the plurality of second flow paths may be greater than a number of first flow paths in the plurality of first flow paths.

In an example embodiment, a number of second flow paths in the plurality of second flow paths may be one more than a number of first flow paths in the plurality of first flow paths.

In an example embodiment, when a direction from the fluid inlet to the fluid outlet is referred to as a first direction, a length, in the first direction, of the one second flow path may be longer than a length, in the first direction, of the one first flow path.

In an example embodiment, a ratio of the length of the one first flow path to the length of the one second flow path may be 3:7 to 4:6.

In an example embodiment, when a direction from the fluid inlet to the fluid outlet is referred to as a first direction, and a second direction is one that is perpendicular to the first direction, a width, in the second direction, of the one first flow path may be narrower than a width, in the second direction, of a wall disposed between the two first flow paths.

In an example embodiment, the width of the wall may be at least twice the width of the one first flow path.

In an example embodiment, the width of the one first flow path and the width of the wall may be 1:2 to 1:3.

In an example embodiment, the one first flow path and the one second flow path may have substantially the same width.

In an example embodiment, the separator for an electrochemical device may further include a connection flow path connecting the one first flow path and the one second flow path.

In an example embodiment, when a direction from the fluid inlet to the fluid outlet is referred to as a first direction, the connection flow path may extend in a second direction that is perpendicular to the first direction.

In an example embodiment, the one second flow path may be directly connected to the one first flow path and may extend in a direction inclined with respect to the one first flow path.

In an example embodiment, the plurality of first flow paths may directly connect to the fluid inlet.

In an example embodiment, the plurality of second flow paths may directly connect to the fluid outlet.

Meanwhile, another aspect of the present disclosure provides an electrochemical device including: a plurality of flow paths; and an electrochemical cell disposed between flow paths among the plurality of flow paths, wherein at least one of the plurality of flow paths includes a fluid inlet, a fluid outlet, a plurality of first flow paths connected to the fluid inlet, and a plurality of second flow paths connected to the fluid outlet and the plurality of first flow paths, and in a connection region in which the first and second flow paths are connected, two second flow paths among the plurality of second flow paths and adjacent to each other are connected to one first flow path among the plurality of first flow paths, and two first flow paths among the plurality of first flow paths and adjacent to each other are commonly connected to one second flow path among the plurality of second flow paths.

In an example embodiment, the electrochemical cell may include first and second catalyst electrodes, and a polymer electrolyte membrane disposed between the first and second catalyst electrodes.

In an example embodiment, the electrochemical cell may be a fuel cell or an electrolysis cell.

In the case of a separator for an electrochemical device according to an example embodiment of the present disclosure, high performance thereof may be provided when the separator is applied to an electrochemical device.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1 and 2 schematically illustrate an appearance of a separator for an electrochemical device according to an example embodiment of the present disclosure, and correspond to a perspective view and a cross-sectional view, respectively;

FIG. 3 is a cross-sectional view of FIG. 2;

FIG. 4 is an enlarged view of a partial region in FIG. 2;

FIG. 5 is an enlarged view of a cross-section of a partial region of a separator for an electrochemical device according to a modified embodiment;

FIG. 6 is a graph illustrating a relationship between current density and a voltage according to the flow path shape of a separator;

FIG. 7 is a cross-sectional view illustrating an electrochemical device to which a separator according to an example embodiment of the present disclosure is applied;

FIG. 8 is a cross-sectional view illustrating a membrane-electrode assembly that may be applied to an electrochemical device; and

FIG. 9 is an enlarged view of a partial region in FIG. 8.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. Furthermore, the example embodiments disclosed herein are provided for those skilled in the art to better explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

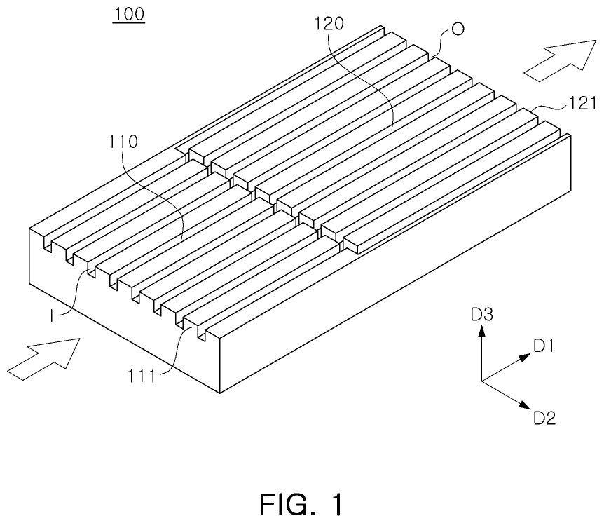

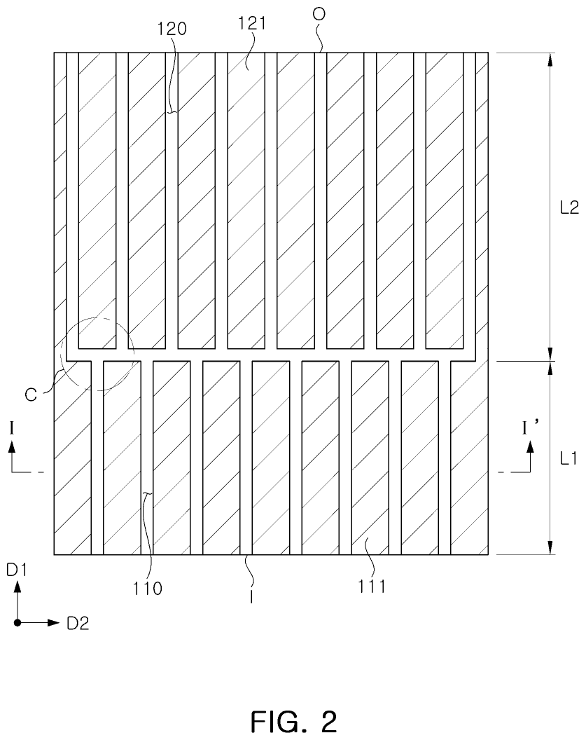

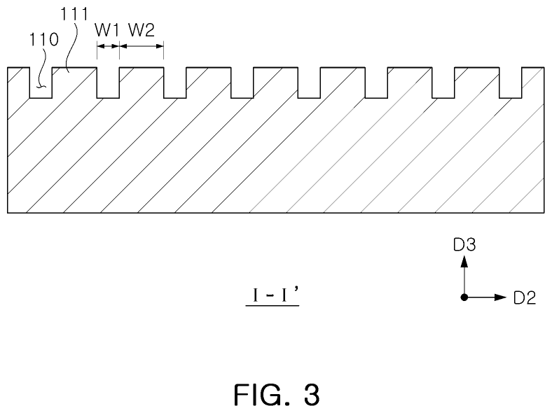

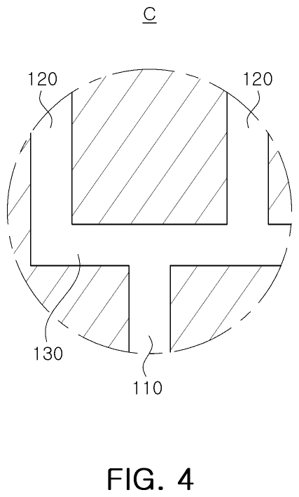

FIGS. 1 and 2 schematically illustrate an appearance of a separator for an electrochemical device according to an example embodiment of the present disclosure, and correspond to a perspective view and a cross-sectional view, respectively, FIG. 3 is a cross-sectional view of FIG. 2, and FIG. 4 is an enlarged view of a partial region in FIG. 2.

Referring to FIGS. 1 to 4, a separator 100 for an electrochemical device according to one embodiment of the present disclosure (hereinafter referred to as a ‘separator for an electrochemical device’ or a ‘separator’) includes a fluid inlet I, a fluid outlet O, a plurality of first flow paths 110, and a plurality of second flow paths 120. Here, in a connection region C in which first and second flow paths 110 and 120 are connected to each other, two second flow paths 120 adjacent to each other are connected to one first flow path 110, and two first flow paths 110 adjacent to each other are commonly connected to one second flow path 120. In other words, the first flow path 110 may have a form of being divided into two second flow paths 120 in a direction of fluid flow from the fluid inlet I indicated by an arrow to the fluid outlet O, while sharing one second flow path 120 with another first flow path 110 adjacent thereto. With this type of flow path structure, the separator 100 may have high efficiency when applied to an electrochemical device. For example, when the separator 100 is used as a water electrolysis device, the hydrogen production efficiency may be increased in an entire region of the separator 100 as a reaction rate is controlled and the current density characteristics are improved in the first flow path 110 and the second flow path 120. Additionally, when the separator 100 is used as a fuel cell device, the power production efficiency may be increased in the entire region of the separator 100.

The separator 100 is a component separating respective unit cells in an electrochemical device and may be formed of a conductive material. Specifically, the separator 100 may be used as a PEMEC or PEMFC. However, the separator 100 may also be used as an SOEC or SOFC, and in this case, the separator 100 may include a metal having a high melting point so as not to melt or be softened at high temperatures. The separator 100 may use a material such as nickel, iron, or stainless steel. Additionally, when an operating temperature of the separator 100 is relatively low, for example, when the operation temperature is low, such as 800° C. or lower, copper or copper alloys having good conductivity may also be used. The separator 100 may include walls 111 and 121 to form a flow path, and as illustrated, the first flow path 110 may be formed by the first wall 111, and the second flow path 120 may be formed by the second wall 121.

The fluid inlet I and the fluid outlet O of the separator 100 do not need to be clearly distinguished from the flow paths 110 and 120, and the fluid inlet I and the fluid outlet O may not be provided as separate components but may be provided portions of the flow paths 110 and 120. Alternatively, the fluid inlet I and the fluid outlet O may not be directly connected to the flow paths 110 and 120 but may have another flow path interposed therebetween.

For example, a metal plate may be processed using an appropriate stamping process, or an etching process to form the walls 111 and 121 in the separator 100. When the separator 100 is used as a water electrolysis device, water or water vapor may be injected through the fluid inlet I, and liquid and water vapor may be injected together. Hydrogen gas may be discharged through the fluid outlet O, or vice versa when used as a fuel cell. However, the fluid inlet I and the fluid outlet O may be changed depending on a direction of fluid injection. Hereinafter, the function of the flow paths 110 and 120 will be described by taking a case in which the separator 100 is applied to a side of the fuel electrode of the water electrolysis device as a main example. In the case of the separator 100 disposed on a side of the fuel electrode of the water electrolysis device, water may be injected from the fluid inlet I, and as a fluid flows along the separator 100, the amount of water may decrease and the concentration of hydrogen formed by decomposition of water may increase. While the flow paths 110 and 120 of the separator 100 may supply reactants, the flow paths 110 and 120 may function to move products generated by a reaction to the fluid outlet O and effectively remove the products.

As described above, the separator 100 includes a plurality of first flow paths 110 and a plurality of second flow paths 120. The plurality of first flow paths 110 are connected to the fluid inlet I, and the plurality of second flow paths 120 are connected to the fluid outlet O and the first flow path 110. In the connection region C in which the first and second flow paths 110 and 120 are connected, the two second flow paths 120 adjacent to each other are connected to one first flow path 110, and the two first flow paths 110 adjacent to each other are commonly connected to one second flow path 120. When the separator 100 having such a structure of the flow paths 110 and 120 is used in a water electrolysis device, in the first flow path 110 adjacent to the fluid inlet I, the number of flow paths 110 is relatively small, and accordingly, a contact area between the separator 100 and the electrode of the electrochemical cell is relatively increased. Accordingly, when water passes through the first flow path 110, the reaction may be activated. In contrast, in the second flow path 120 adjacent to the fluid outlet O, the number of flow paths 120 is relatively large, and the contact area between the separator 100 and the electrode of the electrochemical cell is reduced. As a result, the reaction may be suppressed in the second flow path 120, but when the separator 100 is viewed as a whole, a deviation of the reaction and current density in the direction of fluid flow may be reduced, and further, higher current density may be implemented under the same voltage.

As illustrated, a plurality of first flow paths 110 may be linear flow paths. Additionally, a plurality of second flow paths 120 may also be straight flow paths. When a direction oriented from the fluid inlet I to the fluid outlet O is referred to as a first direction D1, and directions, perpendicular thereto, are referred to as a second direction D2 and a third direction D3, the first and second flow paths 110 and 120 may be straight flow paths extending in the first direction D1. Additionally, as described above, the first flow path 110 may be connected to the fluid inlet I and the second flow path 120 may be connected to the fluid outlet O to form an integral structure. In this example embodiment, the first direction D1 represents an up-down direction based on FIG. 2, but the direction need not be strictly limited, and when the direction is directed from the fluid inlet I to the fluid outlet O, this may be an inclined direction rather than a vertical direction.

A more specific example of the flow path shape and arrangement of the separator 100 will be described. As the first flow path 110 branches into two second flow paths 120, the number of the plurality of second flow paths 120 may be greater than the number of the plurality of first flow paths 110. Furthermore, in this example embodiment, the first flow paths 110 adjacent to each other may share the second flow path 120, and accordingly, the number of the plurality of second flow paths 120 may be one more than the number of the plurality of first flow paths 110.

Lengths of the first flow path 110 and the second flow path 120 may be adjusted in terms of reducing the dispersion of the current density according to the flow of the fluid. Specifically, a length L2 of the second flow path 120 may be longer than a length L1 of the first flow path 110 based on the length in the first direction D1. According to the research of the inventors of the present disclosure, when the length L2 of the second flow path 120, which corresponds to the latter half of the fluid flow, is made relatively longer than the length L1 of the first flow path 110, which corresponds to the former half of the fluid flow, and a region in which the reaction is suppressed in the latter half is increased, the effect of uniformizing the overall current density in the separator 100 may increase. As a more specific example, a ratio of the length L1 of the first flow path 110 to the length L2 of the second flow path 120 may be 3:7 to 4:6.

In addition to the lengths of the flow paths 110 and 120, widths of the flow paths 110 and 120 and widths of the walls 111 and 121 may also be adjusted in terms of uniformizing the current density. Specifically, a width W1 of the first flow path 110 based on the length of the second direction D2 perpendicular to the first direction D1 may be narrower than a distance between the first flow paths 110 adjacent to each other, and here, a distance W2 between the first flow paths 110 adjacent to each other may be defined as the width W2 of the wall 111 disposed between the first flow paths 110 adjacent to each other. In this case, when the width condition simultaneously satisfies conditions of the lengths L1 and L2 of the first and second flow paths 110 and 120 described above, the uniformity of the current density may be further improved. As a more specific example, the width W2 of the wall disposed between the first flow paths 110 adjacent to each other may be at least twice the width W1 of the first flow path 110. Additionally, the width W1 of the first flow path 110 and the width W2 of the wall may be 1:2 to 1:3. In the above-described content, the relationship between the width W1 of the first flow path 110 and the width W2 of the wall has been described, but this may also be applied to the second flow path 120, and in this case, the first flow path 110 and the second flow path 120 may have substantially the same width. As used herein, the phrase “substantially the same width” may refer to the first flow path 110 having the same width as compared to the width of the second flow path 120, and allows for approximations, inaccuracies, limits, and industry-accepted tolerances of measurement under the relevant circumstances. The industry-accepted tolerance may be a tolerance of ±1%, ±5%, or ±10% of the actual value stated. The widths and lengths disclosed herein may be measured by an optical microscope or a scanning electron microscope. Other methods and/or tools appreciated by one of ordinary skill in the art, even if not described in the present disclosure, may also be used.

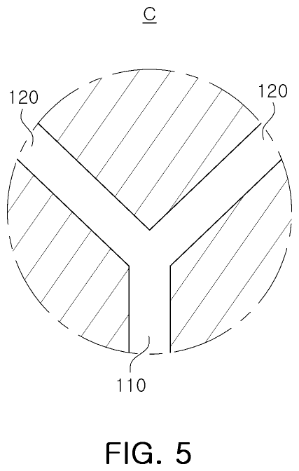

Regarding a connection method of the first flow path 110 and the second flow path 120, the first flow path 110 and the second flow path 120 may be connected by a connection flow path 130 or may be directly connected. The example embodiment of FIG. 2 illustrates a connection structure by a connection flow path 130, and the separator 100 may further include a connection flow path 130 connecting the first flow path 110 and the second flow path 120. Here, the connection flow path 130 may extend in the second direction D2 perpendicular to the first direction D1 in which the first and second flow paths 110 and 120 extend. Alternatively, as in a modified embodiment illustrated in FIG. 5, the second flow path 120 may be directly connected to the first flow path 110, and in this case, the second flow path 120 may extend in a direction inclined with respect to the first flow path 110.

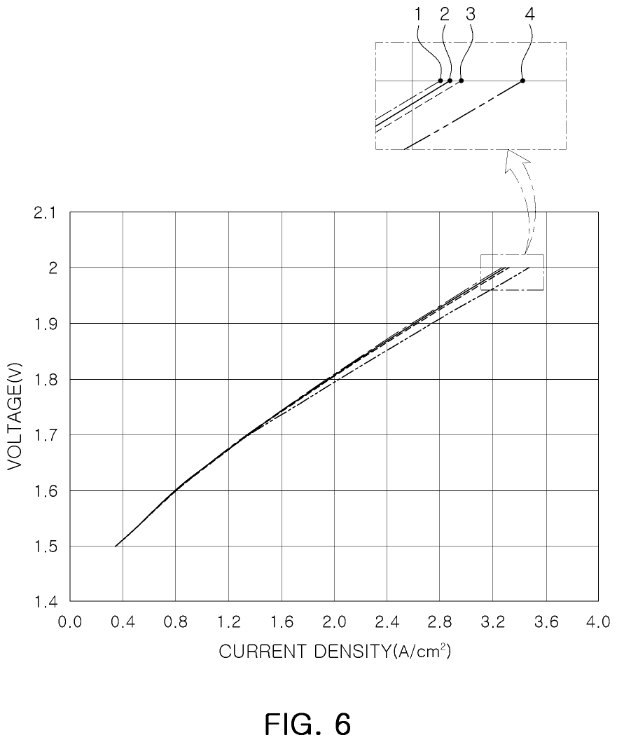

Referring to FIG. 6, the results of comparing the characteristics according to a flow path shape of the separator will be described. FIG. 6 is a graph illustrating a relationship between the current density and the voltage according to the flow path shape of the separator, and here, \textcircled{1}, \textcircled{2}, and \textcircled{3} are results according to the separator according to comparative examples, and \textcircled{4} is a result according to the separator according to an example of the present disclosure. The comparative examples of \textcircled{1}, \textcircled{2}, and \textcircled{3} are not a form separated into the first flow path and the second flow path, but rather have a form in which a single straight flow path extends from the fluid inlet to the fluid outlet. The comparative examples of \textcircled{1}, \textcircled{2}, and \textcircled{3} have different flow path widths and different wall widths disposed between the flow paths adjacent to each other, and the flow path width and the wall width have a ratio of 1:1.2 (\textcircled{1}), 1.2:1 (\textcircled{2}), and 1.4:0.8 (\textcircled{3}), respectively. In the case of the example (\textcircled{4}), a ratio of the length L1 of the first flow path 110 and the length L2 of the second flow path 120 is 4:6, and the width W1 of the first flow path 110 and the width W2 of the wall are set to 3:8 (a width condition of the second flow path is the same as that of the first flow path). According to the experimental results of FIG. 6, it may be confirmed that the separator adopting the first flow path and the second flow paths 110 and 120 as in this example embodiment showed about 5% better performance in a I-V performance curve.

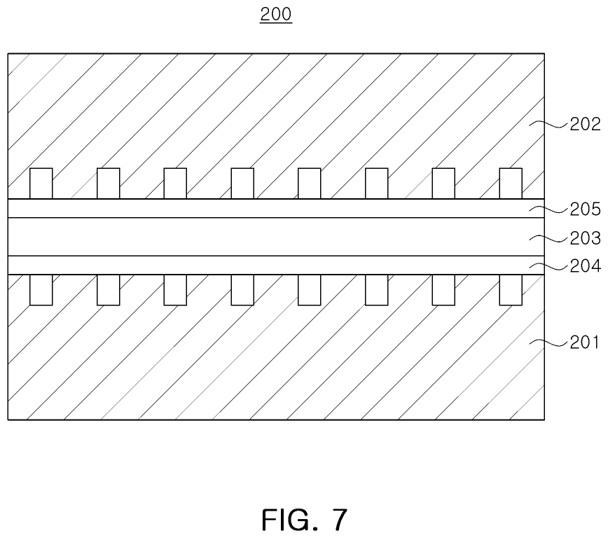

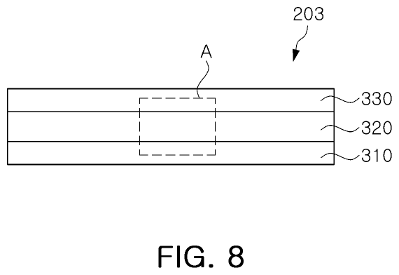

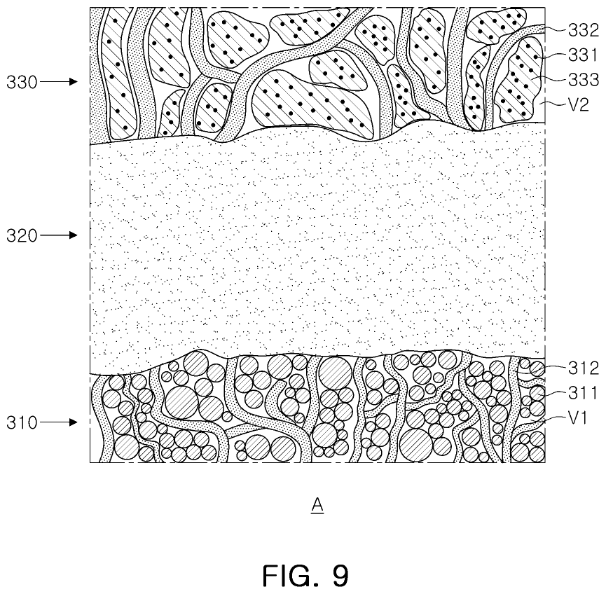

An example of applying the separator described above to an electrochemical device will be described with reference to FIGS. 7 to 9. FIG. 7 is a cross-sectional view illustrating an electrochemical device to which a separator according to an example embodiment of the present disclosure is applied. FIG. 8 is a cross-sectional view illustrating a membrane-electrode assembly that may be applied to an electrochemical device. FIG. 9 is an enlarged view of a partial region in FIG. 8. Hereinafter, an electrochemical device 200 is described based on a water electrolysis device including a membrane-electrode assembly 203 as an electrochemical cell, but this may be applied to other types of electrochemical devices such as fuel cells. Additionally, a solid oxide cell instead of a polymer electrolyte membrane may be used. Referring to FIG. 7, the electrochemical device 200 includes a plurality of separators 201 and 202 and a membrane-electrode assembly 203 disposed therebetween. Additionally, porous current collecting layers 204 and 205 may be disposed between the membrane-electrode assembly 203 and the separator 201 and 202, and it may be preferable that the current collecting layers 204 and 205 may have excellent oxidation resistance to maintain excellent electrical conductivity. When the electrochemical device 200 is used as a water electrolysis device, water may be supplied as fuel, and the water may be electrolyzed and separated into hydrogen and oxygen. In order to improve the function of the electrochemical device 200, a plurality of units including the separator 201 and 202 and the membrane-electrode assembly 203 may be provided and may be repeatedly configured to form a stack body.

As at least one of the plurality of separators 201 and 202, a separator having a flow path structure of the form described above may be adopted, and in this example embodiment, an example of applying this structure to all of the plurality of separators 202 and 202 is shown. Alternatively, the separator of the present disclosure may be applied only to the fuel electrode-side separator 201.

The membrane-electrode assembly 203 will be described with reference to FIGS. 8 and 9. The membrane-electrode assembly 203 includes a first catalyst electrode 310, a polymer electrolyte membrane 320, and a second catalyst electrode 330 as main components, and the polymer electrolyte membrane 320 is disposed between the first and second catalyst electrodes 310 and 330. The first catalyst electrode 310 may include a first catalyst 311, and may include an aggregate of particles of the first catalyst 311 as illustrated in FIG. 9. In addition to the first catalyst 311, the first catalyst electrode 310 may include an ion conductor 312, and the ion conductor 312 may function as a binder of the first catalyst 311. Additionally, pores V1 may be formed within the first catalyst electrode 310 so that gas, liquid, and the like, may move smoothly. The first catalyst 311 may include an Ir-based material, a Ru-based material, or a Ti-based material that is activated in an oxygen generation reaction. The ion conductor 312 may provide a movement path for hydrogen ions, and the like, generated from the first catalyst electrode 310, and may include, for example, a fluorine-based ionomer, a carbon-hydrogen-based ionomer, and a mixture thereof. As a specific example, the ion conductor 312 may include a perfluorinated sulfonic acid ionomer. In the case of a water electrolysis cell, the first catalyst electrode 310 is an anode, and water supplied thereto may be separated into oxygen (O₂), hydrogen ions (H⁺, protons), and electrons. Here, the hydrogen ions may move to the second catalyst electrode 330 through the polymer electrolyte membrane 320, and the electrons may move to the second catalyst electrode 330 through an external circuit and a power supply.

The polymer electrolyte membrane 320 may include an ion conductor to provide a movement path for hydrogen ions, and the like. Here, the ion conductor of the polymer electrolyte membrane 320 may include, for example, a fluorine-based ionomer, a carbon-hydrogen-based ionomer, and a mixture thereof. As a specific example, the ion conductor 312 may include a perfluorinated sulfonic acid ionomer. In the case of a water electrolysis cell, hydrogen ions generated in the first catalyst electrode 310 may move to the second catalyst electrode 330 through the polymer electrolyte membrane 320. As illustrated, the polymer electrolyte membrane 320 may cover a side surface S1 and an upper surface S2 of the first catalyst electrode 310, thereby increasing an interface therebetween. When the interface between the polymer electrolyte membrane 320 and the first catalyst electrode 310 is increased in this manner, material exchange therebetween may be activated, and the reaction efficiency in the catalyst electrodes 310 and 330 may be improved.

The second catalyst electrode 330 includes a second catalyst 331, which is disposed on the polymer electrolyte membrane 320. In this case, the second catalyst 331 may be loaded in a support 333 as illustrated in FIG. 9. Additionally, the second catalyst electrode 330 may include an ion conductor 332, and the ion conductor 332 may function as a binder for the second catalyst 331 and the support 333. Additionally, pores V2 may be formed within the second catalyst electrode 330 so that gas, liquid, and the like, may move smoothly. The second catalyst 331 is active in a hydrogen oxidation reaction or an oxygen reduction reaction, and may include platinum (Pt), gold (Au), ruthenium (Ru), osmium (Os), palladium (Pd), and alloys thereof. The ion conductor 332 may provide a migration path for hydrogen ions, and the like, and may include, for example, a fluorine-based ionomer, a carbon-hydrogen-based ionomer, and a mixture thereof. As a specific example, the ion conductor 332 may include a perfluorinated sulfonic acid ionomer. The support 333 may be formed as a porous body having a high surface area so as to be able to support a large amount of the second catalyst 331, and for example, a carbon-based support may be used. In the case of the water electrolysis cell, the second catalyst electrode 330 may be a cathode, and hydrogen ions supplied through the polymer electrolyte membrane 320 may react with electrons to generate hydrogen.

The present disclosure is not limited by the above-described example embodiments and the attached drawings, but is limited by the appended claims. Accordingly, it will be understood by those skilled in the art that various substitutions, modification and changes in form and details may be made therein without departing from the spirit and scope of the present disclosure as defined by the appended claims, and these replacements, modifications, or changes should be construed as being included in the scope of the present disclosure.

What is claimed is:

1. A separator for an electrochemical device, comprising:
a fluid inlet;
a fluid outlet;
a plurality of first flow paths connected to the fluid inlet; and
a plurality of second flow paths connected to the fluid outlet and the plurality of first flow paths,
wherein in a connection region in which the plurality of first flow paths and the plurality of second flow paths are connected to each other, two second flow paths among the plurality of second flow paths and adjacent to each other are connected to one first flow path among the plurality of first flow paths, and two first flow paths among the plurality of first flow paths and adjacent to each other are commonly connected to one second flow path among the plurality of second flow paths.

2. The separator for an electrochemical device according to claim 1, wherein at least one first flow path among the plurality of first flow paths is a linear flow path.

3. The separator for an electrochemical device according to claim 1, wherein at least one second flow path among the plurality of second flow paths is a linear flow path.

4. The separator for an electrochemical device according to claim 1, wherein a number of second flow paths in the plurality of second flow paths is greater than a number of first flow paths in the plurality of first flow paths.

5. The separator for an electrochemical device according to claim 1, wherein a number of second flow paths in the plurality of second flow paths is one more than a number of first flow paths the plurality of first flow paths.

6. The separator for an electrochemical device according to claim 1, wherein when a direction from the fluid inlet to the fluid outlet is referred to as a first direction, a length, in the first direction, of the one second flow path is longer than a length, in the first direction, of the one first flow path.

7. The separator for an electrochemical device according to claim 6, wherein a ratio of the length of the one first flow path to the length of the one second flow path is 3:7 to 4:6.

8. The separator for an electrochemical device according to claim 1, wherein when a direction from the fluid inlet to the fluid outlet is referred to as a first direction, and a second direction is one that is perpendicular to the first direction, a width, in the second direction, of the one first flow path is narrower than a width, in the second direction, of a wall disposed between the two first flow paths.

9. The separator for an electrochemical device according to claim 8, wherein the width of the wall is at least twice the width of the one first flow path.

10. The separator for an electrochemical device according to claim 8, wherein the width of the one first flow path and the width of the wall are 1:2 to 1:3.

11. The separator for an electrochemical device according to claim 8, wherein the one first flow path and the one second flow path have substantially the same width.

12. The separator for an electrochemical device according to claim 1, further comprising:
a connection flow path connecting the one first flow path and the one second flow path.

13. The separator for an electrochemical device according to claim 12, wherein when a direction from the fluid inlet to the fluid outlet is referred to as a first direction, the connection flow path extends in a second direction that is perpendicular to the first direction.

14. The separator for an electrochemical device according to claim 1, wherein the one second flow path is directly connected to the one first flow path and extends in a direction inclined with respect to the one first flow path.

15. The separator for an electrochemical device according to claim 1, wherein the plurality of first flow paths directly connects to the fluid inlet.

16. The separator for an electrochemical device according to claim 1, wherein the plurality of second flow paths directly connects to the fluid outlet.

17. An electrochemical device, comprising:
a plurality of flow paths; and
an electrochemical cell disposed between flow paths among the plurality of flow paths,
wherein at least one of the plurality of flow paths includes a fluid inlet, a fluid outlet, a plurality of first flow paths connected to the fluid inlet, and a plurality of second flow paths connected to the fluid outlet and the plurality of first flow paths, and
in a connection region in which the first and second flow paths are connected, two second flow paths among the plurality of second flow paths and adjacent to each other, are connected to one first flow path among the plurality of first flow paths, and two first flow paths among the plurality of first flow paths and adjacent to each other are commonly connected to one second flow path among the plurality of second flow paths.

18. The electrochemical device according to claim 17, wherein the electrochemical cell includes first and second catalyst electrodes, and a polymer electrolyte membrane disposed between the first and second catalyst electrodes.

19. The electrochemical device according to claim 17, wherein the electrochemical cell is a fuel cell or an electrolysis cell.
